(19) United States
(12) Patent Application Publication
(10) Pub. No.: US 2004/0138348 A1
(43) Pub. Date: Jul. 15, 2004

(54) Pigmentary compositions

(76) Inventor: Fridolin Babler, Hockessin (DE)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/475,481

(22) PCT Filed: May 7, 2002
(86) PCT No.: PCT/EP02/05034

(51) Int. Cl. C08K 5/34

(52) U.S. Cl. 524/88

(57) ABSTRACT

The present invention relates to pigmentary compositions comprising polyamide particles with an average particle size of below 50 μm and optionally a dye precipitate. The inventive pigmentary compositions are useful for coloring high molecular weight material, like coatings, inks and in particular plastics like polyvinyl chloride, polyamide, polyester, polycarbonate and, especially polyamide fibers.

The present invention relates to new pigmentary compositions and a method of using the pigmentary compositions to color various substrates like high molecular weight material.

Due to unusually good mechanical properties, such as toughness, pliability, elasticity, and mechanical strength, polyamides belong to a class of high performance polymers with significant technical importance.

Polyamides pertain to the polar polymers with a high melting point of generally above 250° C. Only high performance pigments with outstanding heat stability can be used for coloring polyamides in the extrusion process. Since few organic pigments possess the properties needed to color polyamide, the availability of shades is limited. For this reason, large quantities of polyamide fibers are still bath dyed using special dyes like for example the acid dyes.

Many patents describe the dyeing of polyamide materials with dyes, in particular with acid dyes. For example U.S. Pat. No. 3,619,123 describes a process for dyeing synthetic polyamide fibers in the presence of one or more aromatic sulfonic acids to produce uniform dyed fibers. U.S. Pat. No. 4,438,140 describes salts of acid colorants and specified copolymers containing tertiary amino groups for its use in cosmetics. U.S. Pat. No. 6,136,433 describes melt-spinning a nylon fiber from a host polymer formed from a mixture of amide monomers and at least one hindered piperidine compound. A colorant is dispersed throughout the host polymer.

U.S. Pat. No. 4,374,641 describes a polymeric color concentrate for thermoplastic polymeric materials and solution dyeing of a nylon fiber. The color concentrate is prepared from a blend of water or organic solvent-dispersible polymer and a soluble dye or pigment. The preferred polymer is a polyamide blend with a polyamide component having improved basic dye affinity, as described in U.S. Pat. No. 3,846,507.

U.S. Pat. No. 4,492,686 claims cosmetic make-up compositions containing one or more colored pigments in a carrier or diluent, wherein the pigment is a salt obtained by reacting a polymer containing primary or secondary amine groups with at least 10% of the stoichiometric amount of an acid dyestuff as free acid or salt. Japanese Patent No. 60/162,881 describes shaped goods comprising of a polyamide and melamine derivative by immersing the shaped goods in an aqueous solution containing 0.1 to 1.5 wt. % of acetic or formic acid or ammonium sulfate at 40 to 45° C. and adding 0.1 to 1.0 wt. % of an acid dyestuff, elevating the temperature of the dyeing solution to 80 to 100° C. in 30 to 60 minutes and maintaining that temperature for 30 to 60 minutes then washing and drying the goods.

Published PCT patent application WO 00/64953 describes a process for the production of micro-spheres of polymers and polymeric pigments. These products are composed mainly of polymers and copolymers containing specific functional groups to provide them specific properties and a higher affinity to colorants.

U.S. Pat. No. 5,874,091 relates to cosmetic compositions that contain particulate filler that has been combined with at least one melanin pigment.

Surprisingly, it was found that specific polyamide powders colored by appropriate dyes provide new pigmentary compositions that can be used, effectively for coloring high molecular weight material like inks, coatings and plastics, especially plastics formed or shaped by the extrusion process.

Thus, the present invention relates to pigmentary compositions comprising from 30 to 100 parts by weight of polyamide particles having an average particle size below 50 μm and a coloring agent affixed on or therein, and from 0 to 70 parts by weight of a dye precipitate, wherein the parts by weight of the polyamide particles and precipitate total 100 parts by weight, a method for their preparation and their use for coloring substrates, for example high molecular weight materials, in particular high performance engineering plastics, such as polyamides, especially polyamide fibers.

The new pigmentary compositions have unique properties and can be used for the coloration of a variety of substrates. For example they allow the coloring of polyamide fibers in various shades currently obtained only by the environmentally unfriendly and uneconomic aqueous dyeing processes using an environmentally friendlier melt spinning process.

Preferably, the inventive pigmentary composition is prepared by coloring a polyamide particulate material with a coloring agent in an aqueous media, isolating the colored polyamide for instance by filtration and drying. The isolated colored polyamide material is in a powder form consisting of a colored particulate finely divided solid, which can be incorporated into a substrate like an organic pigment. Depending on the substrate to be colored the inventive pigmentary compositions are when applied finely dispersed or in a polyamide-compatible substrate partially or completely dissolved.

The coloring agent is a dye compound. Pigments are inorganic or organic, colored, white or black particulate materials that are practically insoluble in a medium in which they are incorporated. Dyes, on the other hand, dissolve in a selected medium and, in the process, lose their distinct crystal or particulate structure. The coloring agent is not a pigment, especially not a melanin or related indole derivatives as described in U.S. Pat. No. 5,874,091, which is incorporated herein by reference. The inventive composition comprising of the colored polyamide particulate material is a pigmentary composition even though the polyamide particulate material was originally colored using a dye.

In general the polyamide particulate is a polyamide filler consisting essentially of particles having an average particle size below 50 μm, in particular in the range of from 1 to 40 μm; especially from 2 to 30 μm; most preferably in the range of from 1 to 25 μm. The desired polyamide particulate material has a relatively narrow size distribution such that 90% by number have a size below 30 μm, preferably 90% by number have a size between 1 and 25 μm. The polyamide particles can have any shape, preferably they are composed primarily of particles having a spherical shape.

Advantageously, the polyamide particulate material has a porous surface. In general, the expression “porous surface” means that there are numerous holes or pores in the surface of the polyamide particle and a porous network within the particle confines. In general, the pores mainly have a size in the range of from 0.05 to 0.6 μm; alternatively in the range from 0.05 to 0.4 μm or in the range from 0.1 to 0.4 μm. The preferred porous material is described as having an essentially spheroidal spongy structure in the form of a “gypsum rose”. The “gypsum rose” structure is defined, in mineralogical analogy to the desert rocks thus called, as particles having a lamellar or shell-like structure whose lamellae, which grow anarchically and are connected to each other, form cavities whose geometric shapes vary between the conical and pyramidal shapes, and the apices of these geometric forms are directed toward the center of the particle. The walls of the cavities, having marked borders, generally have thicknesses smaller than 0.2 micron, the thickness of the middle lamella forming these walls being generally even smaller than 0.1 micron. The porous structure is advantageous because it increases the surface, interior and exterior, available for dye attachment.

The pore size is easily measured by scanning electron microscopy. Typically, a scanning electron micrograph shows pumiceous spherical particles, which have surface pores.

Suitable polyamide fillers are in particular those composed of polymerized lauryl lactam or caprolactam, or polymerized mixtures thereof. Most preferably, the filler is a polyamide-12, a polyamide-6 or a co-polyamide-6/12 filler. Highly suitable polyamide fillers are commercially available, for example, various ORGASOL® types sold by the company Atofina.

The process by which these fillers are obtained is described in U.S. Pat. No. 4,831,061, FR 2,619,385 or published European patent 303,530, the disclosures of which are hereby incorporated by reference. These polyamide particles, moreover, are known, according to their various physicochemical properties, under the name “nylon-12” or “nylon-6”.

Preferably, the specific surface area of the polyamide particulate material according to this invention is above 0.1 m²/g, especially in the range from 0.1 to 12 m²/g. Most preferably, the specific surface area is above 1 m²/g, especially in the range from 2 to 12 m²/g.

Suitable coloring agents include dyes selected from the group consisting of azo, azomethine, methine, anthraquinone, phthalocyanine, dioxazine, flavanthrone, indanthrone, anthrapyrimidine and metal complex dyes.

Many of these dyes are commercially available in the form of acid-, reactive- or metal complex dyes used for coloring wool or nylon fibers. Most appropriate dyes are in particular the anthraquinone dyes, for example Solvent Blue 132, metal complex dyes, for example Solvent Yellow 21, Solvent Red 225, solvent Red 214 and Solvent Violet 46, and azo acid dyes. Particularly interesting are the dyes sold under the tradename Erionyl® and Filamid® by Ciba Speciality Chemicals Inc., such as Filamid® Yellow R, Red GR, Bordeaux R and Violet RB and Erionyl® Violet A-B, Blue A-R, Yellow A-3G, Red A-2BF, Bordeaux A-5B and Black M-BN.

The polyamide particulate material is colored according to known procedures for dyeing nylon fibers. Generally, a selected coloring agent is dissolved in water, the polyamide particulate is added and colored at a temperature of between 90 to 120° C. The temperature as well as the optimum pH can vary from between 4 and 8 and depends on type of the dye, the shade depth and type of the polyamide. Preferably the pH is kept constant throughout coloring and is advantageously adjusted with a buffer. The dye becomes affixed to an exposed surface on the polyamide particulate material during the dyeing process.

The movement of the coloring agent in or onto the substrate, in this case the polyamide particulate, from a higher to a lower dye concentration is known as migration. Migration depends primarily of the constitution of the dye, but it is also affected to a varying degree by the type of the polyamide particulate material and treatment conditions like temperature, pH, auxiliaries and time.

Auxiliaries, also known as dyeing chemicals or penetration accelerants can be added to the dye solution to more rapidly wet the polyamide filler.

Suitable auxiliaries are for example anionic-, cationic- and nonionic-surface active agents such as for example the sulfonated oils, alkylaryl sulfonates, sulfated alcohols, quaternary ammonium salts of aliphatic- or alkylaryl amines or N-hetero cyclic compounds and the water-soluble polymers, copolymers and/or polymer derivatives.

Such water-soluble polymers, copolymers and/or polymer derivatives are for example polyvinylpyrrolidone, polyacrylic acid, polymethacrylic acid, polymaleic anhydride, polyurethane, polyvinylether, polyvinylalcohol, polyalkylene glycol, polyethylene oxide, cellulose derivatives, polyimine, polyvinylpyridine, or copolymers such as copolymers of acrylic acid with styrene, acrylonitrile, vinylacetate, vinylphosphonate, vinylpropionate, vinylchloride, itaconic acid or maleic anhydride, or a mixture thereof. Suitable polymeric derivatives are for example ethoxylated or propoxylated fatty amines such as ethoxylated cocoalkyl, oleyl or soy alkyl amines; ethoxylated or propoxylated fatty quaternary salts such as ethoxylated cocoalkyltrimethyl ammonium chloride; ethoxylated fatty amides such as ethoxylated oleamides; alkyl-, cycloalkyl- or alkylaryl-oxypoly(ethylenoxy)ethanol, cycloalkyloxypoly(ethylenoxy)laurate or oleate, polyethylene glycol 400 laurate or oleate, alkyl-, cycloalkyl- or alkylaryl-poly(ethylenoxy)carboxylate or phosphonate. An especially preferred cycloalkyloxypoly(ethylenoxy) laurate or oleate is for example a poly(ethylenoxy)-sorbitan laurate or oleate. These or other preferably water-soluble polymers, copolymers and/or polymer derivatives are known per se and are commercially available.

The coloring agent is used as dry powder for example in the commercially available form. However, depending on the coloring agent or for cost reason it can be advantageous to use the coloring agent in the form of an aqueous presscake. By a very economic route the polyamide powder is added in the end step of the dye synthesis prior to its filtration.

By using anionic dyes and depending on the desired properties of the pigment composition as well as to get a high yield, it is advantageous to partially or completely precipitate the non-migrated dye generating a dye precipitate consisting of the following general formula:

[dye]-(Y⁽⁻⁾X⁽⁺⁾)ₘ

wherein Y is SO₃, and X⁽⁺⁾ is H⁽⁺⁾ or a group of the formula Mⁿ⁽⁺⁾/n or N⁽⁺⁾(R)(R₁)(R₂)(R₃), M is a monovalent, divalent or trivalent metal cation, n is 1, 2 or 3, each of R, R₁, R₂ and R₃ is independently hydrogen, C₁-C₁₈-alkyl, C₅-C₆-cycloalkyl, phenyl or phenyl which is substituted by C₁-C₁₈-alkyl, or R₂ and R₃, together with the linking nitrogen atom, are a pyrrolidine, imidazoline, piperidine, piperazine, morpholine or abietyl radical, or R₁, R₂ and R₃, together with the linking nitrogen atom, are a pyrrole, pyridine, picoline, pyrazine, quinoline or isoquinoline radical, and m is a value from 1 to 3. “[dye]” is the residue of a chromophor selected from the group consisting of azo, azomethine, methine, anthraquinone, phthalocyanine, dioxazine, flavanthrone, indanthrone, anthrapyrimidine and metal complex dyes.

X⁽⁺⁾ is preferably H⁽⁺⁾ or, most preferably, a group of the formula Mⁿ⁽⁺⁾/n.

X⁽⁺⁾ as a group of the formula Mⁿ⁺⁾/n is for example an alkali metal cation, an alkaline earth metal cation, an aluminum cation or a transition metal cation, for example Na⁽⁺⁾, K⁽⁺⁾, Mg²⁽⁺⁾, Ca²⁽⁺⁾, Sr²⁽⁺⁾, Ba²⁽⁺⁾, Mn²⁽⁺⁾, Cu²⁽⁺⁾, Ni²⁽⁺⁾, Cd²⁽⁺⁾, Co³⁽⁺⁾, Al³⁽⁺⁾ and Cr³⁽⁺⁾, but is preferably an alkaline earth metal cation (n=2) and, most preferably, is aluminum cation and/or Ca²⁽⁺⁾.

C₁-C₁₈-alkyl is for example methyl, ethyl, n-propyl, isopropyl, n-butyl, sec-butyl, tert-butyl, n-pentyl, tert-pentyl, hexyl, heptyl, 2-ethylhexyl, octyl, decyl, dodecyl, tetradecyl, hexadecyl, heptadecyl or octadecyl.

R, R₁, R₂ and R₃ as C₅-C₆-cycloalkyl may be cyclopentyl or, preferably, cyclohexyl.

R, R₁, R₂ and R₃ as phenyl substituted by C₁-C₁₈-alkyl is preferably phenyl which is substituted by C₁₂-C₁₈-alkyl. N⁽⁺⁾(R)(R₁)(R₂)(R₃) may be: N⁽⁺⁾H₄, N⁽⁺⁾H₃ CH₃, N⁽⁺⁾H₂(CH₃)₂, N⁽⁺⁾H₃C₂H₅, N⁽⁺⁾H₂ (C₂H₅)₂, N⁽⁺⁾H₃ iso-C₃H₇, N⁽⁺⁾H₃ C₆H₁₁N⁽⁺⁾H₂ (C₆H₁₁)₂, N⁽⁺⁾H₂ (CH₃)(C₆H₅), N⁽⁺⁾H₃ C₆H₅, N⁽⁺⁾H₃ p-nC₁₈H₃₇-C₆H₅ and N⁽⁺⁾ (CH₃)₄.

Preferably m is 1.

Thus, the inventive pigment compositions can comprise of the dyed polyamide particulate material and of a precipitate of an acid dye or a dye salt. Such products possess a high color strength. They are environmentally friendly and economic because they can be isolated by filtration with a high yield.

Typically, the inventive pigmentary composition is prepared in any suitable equipment like a kneader, shaker or preferably a vessel with a stirrer by

a. dissolving a coloring agent, such as a dye, in an aqueous coloring medium, such as water, optionally in the presence of a surface active agent and a buffer,

b. adding polyamide particulates to form a suspension and stirring the suspension at a temperature above room temperature, preferably above 80° C., for 1 to 6 hours to get a high migration,

c. optionally adding an acid and/or a metal salt and/or an organic amine to precipitate the non-migrated dye, and

d. isolating the resulting pigmentary composition by filtration, washing and drying.

Generally, the dried pigmentary compositions comprise of 30 to 100 parts by weight of a colored polyamide particulate material and 0 to 70 parts by weight of the dye precipitate, preferably of 50 to 100 parts by weight of the colored polyamide particulate material and 0 to 50 parts by weight of the dye precipitate.

Generally, the colored polyamide particulate material comprises around 1 to 40 parts by weight, preferably 5 to 35 parts by weight coloring agent and 60 to 99 parts by weight, preferably 65 to 95 parts by weight polyamide particles. Typically, the pigmentary compositions comprise 20 to 60, preferably 30 to 40 parts by weight coloring agent and dye precipitate and 80 to 40 parts by weight, preferably 70 to 60 parts by weight polyamide particles.

The dried pigmentary compositions are generally used in the form of a powder, which is incorporated into the substrate to be pigmented.

The pigmentary composition consists of or consists essentially of the colored polyamide particulate material and optionally the dye precipitate, as well as customary additives for pigmentary compositions. Such customary additives include texture-improving agents and/or antiflocculating agents.

Typical texture-improving agents include fatty acids having at least 12 carbon atoms, and amides, esters or salts of fatty acids. Fatty acid derived texture-improving agents include fatty acids such as lauric acid, stearic acid or behenic acid, and fatty amines like lauryl amine, stearyl amine, oleyl amine, soja alkylamin, cocoalkyldimethylamine, dimethyloleylamine or dicocoalkylmethylamin. In addition, fatty alcohols or ethoxylated fatty alcohols, polyols, like aliphatic 1,2-diols or polyvinyl alcohol and epoxidized soy bean oil, waxes, resin acids and resin acid salts are suitable texture-improving agents.

Antiflocculating agents, also described as rheology improving agents or particle growth inhibitors, are well known in the pigment industry and include particularly pigment derivatives like the sulfonic acid, sulfonic acid salts or sulfonamide derivatives. Typically, they are used in a concentration of 0.5 to 8 percent based on the pigmentary composition.

The customary additives are incorporated into the pigmentary composition before, during or after the preparation step. Thus, the inventive pigmentary compositions further can contain additives in an amount of from 0.05 to 20 percent by weight, based on the colored composition.

The compositions of this invention are suitable for use as pigments for coloring substrates, such as high molecular weight organic materials.

Consequently, the present invention also relates to a method for coloring a solid or liquid substrate comprising incorporating an effective pigmenting amount of the inventive pigmentary composition into said substrate.

In general, an effective pigmenting amount is any amount which results in the desired coloristic properties in the final pigmented material. In general, an effective pigmenting amount is from 0.1 to 30 percent by weight, preferably 0.1 to 10 percent by weight, based on the substrate.

Examples of high molecular weight organic materials which may be colored or pigmented with the inventive pigment compositions are cellulose ethers and esters such as ethyl cellulose, nitrocellulose, cellulose acetate, cellulose butyrate, natural resins or synthetic resins such as polymerization resins or condensation resins, for example aminoplasts, in particular urea/formaldehyde and melamine/formaldehyde resins, alkyd resins, phenolic plastics, polycarbonates, polyolefins, polystyrene, polyvinyl chloride, polyamides, polyurethanes, polyesters, rubber, casein, silicone and silicone resins, singly or in mixtures.

Preferred high molecular weight organic materials are polyamides, such as “polyamide 12”, “polyamide 6” or a copolymer thereof, polyesters, polycarbonates and mixtures thereof, especially preferred are polyamide- or polyester-type fibers as well as soft, medium hard and hard polyvinyl chloride.

The above high molecular weight organic materials may be used singly or as mixtures in the form of plastics, melts or of spinning solutions, varnishes, paints or printing inks. The inventive pigmentary compositions are preferably employed in an amount of 0.1 to 30 percent by weight, based on the high molecular organic material to be pigmented.

The pigmenting of the high molecular weight organic materials with the compositions of the invention is carried out for example by incorporating such a composition, optionally in the form of a masterbatch, into the substrates using roll mills, mixing or grinding machines. The pigmented material is then brought into the desired final form by methods which are known per se, for example calendering, molding, extruding, coating, spinning, casting or by injection molding. It is often desirable to incorporate plastizisers into the high molecular weight compounds before processing in order to produce non-brittle moldings or to diminish their brittleness. Suitable plasticizers are for example esters of phosphoric acid, phthalic acid or sebacic acid. The plastizisers may be incorporated before or after working the composition into the polymers. To obtain different shades, it is also possible to add fillers or other chromophoric components such as organic or inorganic pigments like white, colored or black, effect, fluorescent or phosphorescent pigments, in any amount, to the high molecular weight organic compounds, in addition to the pigmentary composition of this invention.

Although the new pigmentary compositions show a good light and heat stability it can be advantageous to apply the present compositions in the presence of commonly known and commercially available antioxidants, UV absorbers, light stabilizers, processing agents and so forth.

For pigmenting coatings, varnishes and printing inks, the high molecular weight organic materials and the inventive pigmentary compositions, together with optional additives such as fillers, other pigments, siccatives, light or UV stabilizers, are finely dispersed or dissolved in a common organic solvent or mixture of solvents. The procedure may be such that the individual components by themselves, or also several jointly, are dispersed or dissolved in the solvent and subsequently all the components are mixed.

The colorations obtained, for example in plastics, filaments, coatings, varnishes or prints, have good all-round fastness properties such as an high transparency, good fastness to over-spraying, migration, heat, light, and weathering.

The pigmentary compositions of this invention are also suitable for use as colorants for paper, mineral oil, a solid or liquid polymeric material, leather, inorganic materials, seeds, and in cosmetics.

Due to the chemical resistance, abrasion and scratch resistance and high melting point of the polyamide particulate material used, the new pigmentary compositions can be incorporated in solvent and water based paint and ink systems and also in powder coatings and UV or EB cross linking coating systems. In such systems, for example in coil coatings, external can coatings, non sliding paints for play grounds, varnishes for rubber, paints for automotives or composites and so on they are useful. Additionally, they can be applied in combination with other conventional pigments in such substrates providing unique and durable color shades.

Thus, the present invention also relates to a method for coloring a substrate comprising applying a coating composition that contains an effective pigmenting amount of a pigmentary composition according to the invention.

The coating composition is, for example, a heat curable, air-drying or physically drying, or cross-linking chemically reactive coating system, or a stowing finish containing a binder selected from the group consisting of cellulose ethers, cellulose esters, polyurethanes, polyesters, polycarbonates, polyolefins, polystyrene, polysulfones, polyamides, polycycloamides, polyimides, polyethers, polyether ketones, polyvinyl halides, polytetrafluoroethylene, acrylic and methacrylic polymers, rubber, silicone polymers, phenol/formaldehyde resins, melamine/formaldehyde resins, urea/formaldehyde resins, epoxy resins, diene rubbers and copolymers thereof, or an aqueous or solvent based automotive paint, a powder coating or an UV, EB curing coating system.

The inventive pigmentary compositions are particularly suitable for coloring thermoplastics including polypropylene, polyethylene, and especially soft, medium hard and hard polyvinyl chloride. For example in soft and medium hard polyvinyl chloride very attractive, high chroma, highly transparent and migration resistant coloration's can be generated.

Surprisingly, it was discovered that colorations having a unique reflection spectra could be generated when using the appropriate dye or mixtures of dyes according to the present invention. As described in Example 25 when using for example a black metal complex dye, such as a chromium complex dye, like Erionyl Black M-BN from CIBA Specialty Chemicals Corp. a pigmentary composition is obtained which when applied in nylon fibers generates black colors with a strong absorption between 400 and 640 nm and starting strongly to reflect above 640 nm and in the near IR region.

The pigmentary compositions of this invention are especially suitable for the coloring of nylon articles, such as moldings or notably nylon fibers. In particular, when using anthraquinone acid dyes or anthraquinone reactive dyes for the preparation of the pigmentary compositions according to this invention, they manifest an excellent light stability and a high heat stability.

The inventive pigmentary compositions can be easily compounded with nylon-6 by an extrusion process, then granulated and spun to fibers. Surprisingly, no pigment aggregates can be observed under the microscope in such colored fibers. The fibers have the appearance of a dyed fiber. Due to the outstanding dispersibility behavior or even partial or complete solubility and compatibility with nylon, the inventive pigmentary compositions have the great advantage versus conventional organic or inorganic pigments of no pressure build up during the spinning procedure due to a clocking up of the spinnerets by pigments or aggregates.

Therefore, with the new pigmentary compositions nylon fibers can be colored to obtain shades and fiber properties with a durability and a high transparency similar to bath dyed fibers with the great advantage of using the more economic and environmentally considerably more friendly melt spinning process.

The following examples further describe embodiments of this invention. The scope of the invention is not limited to the foregoing examples. In these examples all parts given are by weight unless otherwise indicated.

The particle sizes and particle size distributions of the fillers given in the following examples are determined as described below:

Particle size distribution is determined in accordance with the principle of Fraunhofer light diffraction. A laser beam passes through the sample and the resulting diffraction pattern is focused on a multi-element detector. Since the diffraction pattern depends, among other parameters, on particle size, particle size distribution can be calculated on the basis of the measured diffraction pattern of the sample. The cumulative volume distribution is determined using a Fraunhofer diffraction instrument, e.g. a COMPETITION/5-HELOS/KA, from SYMPATEC GmbH, D-38644 Goslar, in accordance with the instruction manual.

### EXAMPLE 1

A 2 liter flask equipped with a stirrer, condenser and a thermometer is charged with 800 ml water, 0.8 grams IRGALEV A and 0.8 grams CIBAFLOW R both surface active dyeing auxiliaries from Ciba Specialty Chemicals Corp. and eight grams Erionyl Blue A-R, an anthraquinone acid dye from Ciba Specialty Chemicals Corp., and the mixture is stirred for 30 minutes at 90-95° C. resulting in a dark blue solution. 50 grams ORGASOL 2001 UD NAT, a spherical porous polyamide-12 filler with an average particle size of 2 to 8 μm from Atofina, 1.0 gram sodium acetate and 0.5 grams acetic acid are added. The mixture is stirred at 90-95° C. for 2 hours resulting in a blue suspension. The blue suspension is hot filtered and washed with hot water until the wash liquid turns practically color free. The press cake is dried yielding a blue colored pigmentary composition, which is insoluble in water.

By rubout according to ASTM method D-387-60 in a lithographic varnish (a Nuodex lead/manganese drier from Blackman Uhler Chemical Comp.), the pigmentary composition shows a saturated bright blue color.

### EXAMPLE 2

A 2 liter flask equipped with a stirrer, condenser and a thermometer is charged with 800 ml water, 0.8 grams IRGALEV A and 8 grams Erionyl Blue A-R. The mixture is stirred for 30 minutes at 90-95° C. 50 grams ORGASOL 2001 UD NAT, 1.0-gram sodium acetate and 0.5 grams acetic acid are added. The mixture is stirred at 90-95° C. for 2 hours resulting in a blue suspension. 10 grams alum, an aluminum sulfate from DELTA Corp. are added precipitating the most part of the non migrated dye and the mixture is stirred for 15 minutes at 90-95° C. The dark blue suspension is filtered and the presscake is washed salt free with hot water. The presscake is dried and pulverized, yielding a blue pigmentary composition.

By rubout according to ASTM method D-387-60 in a lithographic varnish, the pigmentary composition shows a strong saturated bright blue color.

### EXAMPLE 3

The procedure of Example 1 is repeated using instead of 8 grams Erionyl. Blue A-R, 8 grams of the anthraquinone acid dye Erionyl Violet A-B from Ciba Specialty Chemicals Corp., yielding a violet pigmentary composition.

By rubout according to ASTM method D-387-60 in a lithographic varnish, the pigmentary composition shows a saturated violet color.

### EXAMPLE 4

The procedure of Example 2 is repeated using instead of 8 grams Erionyl Blue A-R, 8 grams of the anthraquinone acid dye Erionyl Violet A-B, yielding a strong colored violet pigmentary composition.

By rubout according to ASTM method D-387-60 in a lithographic varnish, the pigmentary composition shows a strong violet color.

### EXAMPLE 5

The procedure of Example 1 is repeated using instead of 8 grams Erionyl Blue A-R, 6 grams of the azo acid dye Erionyl Yellow A-3G from Ciba Specialty Chemicals Corp., yielding a yellow pigmentary composition.

By rubout according to ASTM method D-387-60 in a lithographic varnish, the pigmentary composition shows a strong yellow color.

### EXAMPLE 6

The procedure of Example 2 is repeated using instead of 8 grams Erionyl Blue A-R, 8 grams of the acid dye Erionyl Red A-2BF from Ciba Specialty Chemicals Corp., yielding a red pigmentary composition.

By rubout according to ASTM method D-387-60 in a lithographic varnish, the pigmentary composition shows a strong red color.

### EXAMPLE 7

The procedure of Example 2 is repeated using instead of 8 grams Erionyl Blue A-R, 8 grams of the acid dye Erionyl Bordeaux A-5B from Ciba Specialty Chemicals Corp., yielding a Bordeaux colored pigmentary composition.

By rubout according to ASTM method D-387-60 in a lithographic varnish, the pigmentary composition shows a Bordeaux color.

### EXAMPLE 8

The procedure of Example 2 is repeated using instead of 50 grams ORGASOL 2001 UD NAT, 35 grams ORGASOL 1002 D Nat 1, a spherical polyamide-6 filler with an average particle size of around 20 μm from Atofina, yielding a strongly blue colored pigmentary composition.

By rubout according to ASTM method D-387-60 in a lithographic varnish, the pigmentary composition shows a blue color of a high color strength.

### EXAMPLE 9

The procedure of Example 4 is repeated using instead of 50 grams ORGASOL 2001 UD NAT, 25 grams ORGASOL 3202 D Nat 1 a spherical co-polyamide-6,12 filler with an average particle size of around 20 μm from Atofina, yielding a strongly violet colored pigmentary composition.

By rubout according to ASTM method D-387-60 in a lithographic varnish, the pigmentary composition shows a violet color of a high color strength.

### EXAMPLE 10

A 1 liter flask equipped with a stirrer, condenser and a thermometer is charged with 600 ml water, 0.6 grams IRGALEV A and 6 grams Erionyl Violet A-B. The mixture is stirred for 30 minutes at 90-95° C. 10 grams ORGASOL 2001 UD NAT are added. The mixture is stirred at 90-95° C. for 2 hours resulting in a violet suspension. 10 grams alum are added precipitating the most part of the non migrated dye and the mixture is stirred for 15 minutes at 90-95° C. The dark violet-blue suspension is filtered and the presscake is washed salt free with hot water. The presscake is dried, yielding a violet pigmentary composition.

By rubout according to ASTM method D-387-60 in a lithographic varnish, the pigmentary composition shows a strong saturated bright violet color.

### EXAMPLE 11

A 1 liter flask equipped with a stirrer, condenser and a thermometer is charged with 500 ml water, 0.6 grams IRGALEV A and 6 grams Erionyl Blue A-R. The mixture is stirred for 30 minutes at 90-95° C. 1.0-gram sodium acetate and 0.5 grams acetic acid and 10 grams ORGASOL 2001 UD NAT are added. The mixture is stirred at 90-95° C. for 2 hours resulting in a blue suspension. 10 grams alum are added precipitating the most part of the non migrated dye and the mixture is stirred for 15 minutes at 90-95° C. The dark blue suspension is filtered and the presscake is washed salt free with hot water. The presscake is dried, yielding a blue pigmentary composition.

By rubout according to ASTM method D-387-60 in a lithographic varnish, the pigmentary composition shows a strong saturated bright blue color.

### EXAMPLE 12

A 1 liter flask equipped with a stirrer, condenser and a thermometer is charged with 600 ml water, 0.6 grams IRGALEV A and 6 grams Erionyl Black M-BN, a metal complex dye from Ciba Specialty Chemicals Corp. The mixture is stirred for 30 minutes at 90-95° C. 10 grams ORGASOL 2001 UD NAT are added. The mixture is stirred at 90-95° C. for 2 hours resulting in a black suspension. 3.6 grams alum are added precipitating the most part of the non migrated dye and the mixture is stirred for 2 hours without heating, allowing to drop the temperature to 45° C. The dark suspension is filtered and the presscake is washed salt free with hot water. The filtrate and wash liquid is practically color free. The presscake is dried, yielding a black pigmentary composition.

By rubout according to ASTM method D-387-60 in a lithographic varnish, the pigmentary composition shows a strong black color.

### EXAMPLE 13

A 1 liter flask equipped with a stirrer, condenser and a thermometer is charged with 500 ml water, 0.6 grams IRGALEV A and 6 grams Erionyl Red A-2BF. The mixture is stirred for 30 minutes at 90-95° C. 10 grams ORGASOL 2001 UD NAT are added. The mixture is stirred at 90-95° C. for 2½ hours resulting in a red suspension. 1.0 gram Amine 0, a stabilizer additive from Ciba Specialty Chemicals Corp. and 0.6 grams Paraplex G-62, an epoxidized soy beanoil from the C.P. Hall Company are added and the mixture is stirred for 10 minutes at 90 to 95° C. 3.6 grams alum are added precipitating the most part of the non migrated dye and the mixture is stirred for 2 hours without heating, allowing to drop the temperature to 45° C. The red suspension is filtered and the presscake is washed salt free with hot water. The presscake is dried and pulverized, yielding a red pigmentary composition.

By rubout according to ASTM method D-387-60 in a lithographic varnish, the pigmentary composition shows a strong red color.

### EXAMPLE 14

The procedure of Example 13 is repeated, using instead of 6.0 grams Erionyl Red A-2BF, 6.0 grams Erionyl Violet A-B and adding instead of 1.0 gram Amine 0, 2.2 grams lauric acid and instead of 3.6 grams alum, 4.4 grams alum, yielding a strong blue violet pigmentary composition.

By rubout according to ASTM method D-387-60 in a lithographic varnish, the pigmentary composition shows a strong violet color.

### EXAMPLE 15

63.0 grams of polyvinyl chloride, 3.0 grams epoxidized soybean oil, 2.0 grams of barium/cadmium heat stabilizer, 32.0 grams dioctyl phthalate and 1.0 gram of the red pigmentary composition prepared according to Example 13 are mixed together in a glass beaker using a stirring rod. The mixture is formed into a soft PVC sheet with a thickness of about 0.4 mm by rolling for 8 minutes on a two roll laboratory mill at a temperature of 160° C., a roller speed of 25 rpm and friction of 1:1.2, by constant folding, removal and feeding.

The resulting soft PVC sheet is colored in an attractive highly saturated, highly transparent red shade and has excellent fastness to heat, light and migration.

### EXAMPLE 16

The procedure of Example 15 is repeated using instead of the red pigmentary composition of Example 13 the black pigmentary composition prepared according to Example 12 yielding a strongly colored black PVC sheet with similar good fastness properties.

### EXAMPLE 17

The procedure of Example 15 is repeated using instead of the red pigmentary composition of Example 13 the violet pigmentary composition prepared according to Example 14 yielding a strongly colored, highly saturated and highly transparent violet PVC sheet with similar good fastness properties.

### EXAMPLE 18

Five grams of the pigmentary composition prepared according to Example 1, 2.65 grams CHIMASORB 944LD (hindered amine light stabilizer), 1.0 gram TINUVIN 328 (benzotriazole UV absorber) and 2.0 grams IRGANOX B-215 Blend (anti-oxidant), all available from Ciba Specialty Chemicals Corporation, are mixed together with 1000 grams of high density polyethylene at a speed of 175-200 rpm for 30 seconds after flux. The fluxed, pigmented resin is chopped up while warm and malleable, and then fed through a granulator. The resulting granules are molded on an injection molder with a 5 minute dwell time and a 30 second cycle time at a temperature of 200° C. Homogeneously colored chips, which show a royal blue color, are obtained.

### EXAMPLE 19

Nylon-6 granules, Type BS 700 from BASF were dried at 82° C. in a vacuum dryer for 12 hours. The following compound was prepared:

487.75 grams dried nylon-6, 2.5 grams violet pigmentary composition obtained according to Example 4, 1.75 grams calcium stearate, 1.75 grams AC-8A polyethylene from Allied-Signal and 1,25 grams Irganox® B1171, 2.5 grams Chimassorb® 944L and 2.5 grams Tinuvin® 770, all three stabilizer from Ciba Specialty Chemicals Corp. are mixed up and extruded on a Killion single screw extruder and granulated.

The granules were desiccant dried for 18 hours in an oven. The granules were spun into 9 denier fibers under standard conditions resulting in a violet fiber with an attractive appearance. No pressure build up during the spinning process was observed and no aggregates were noticed when the fibers were observed under the microscope.

The fiber was wrapped onto a card and submitted to a light fastness test in a Xenon arc weather-O-meter and exposed for 100 hours AATCC 16 E exposure resulting in a gray scale note of 4 (gray scale 1 to 5 means, 5: best light stability, 1: worst light stability).

Thus, the result showed that nylon-6 fibers colored by the melt spinning process with the present pigmentary composition manifest an excellent heat stability and a light stability in the same range as the known bath dyed colored nylon-6 fibers when using the corresponding dye—in this case Erionyl Violet A-B.

### EXAMPLE 20

The procedure of Example 19 is repeated, however, using instead of 2.5 grams of the violet pigmentary composition prepared according to Example 4, the blue pigmentary composition prepared according to Example 1, yielding blue fibers showing an attractive appearance. No pressure build up during the spinning process was observed and no aggregates were noticed in the fibers when viewed under the microscope.

The fiber was wrapped onto a card and submitted to a light fastness test in a Xenon arc weather-O-meter and exposed for 100 hours AATCC 16 E exposure resulting in a gray scale note of 3-4.

### EXAMPLE 21

The procedure of Example 19 is repeated, however, using instead of 2.5 grams of the violet pigmentary composition prepared according to Example 4, the violet pigmentary composition prepared according to Example 3, yielding violet fibers, which show an attractive appearance. No pressure build up during the spinning process was observed and no aggregates were noticed in the fibers when viewed under the microscope.

The violet fiber was wrapped onto a card and submitted to a light fastness test in a Xenon arc weather-O-meter and exposed for 100 hours MTCC 16 E exposure resulting in a gray scale note of 4.

### EXAMPLE 22

The procedure of Example 19 is repeated, however, using instead of 2.5 grams of the violet pigmentary composition prepared according to Example 4, the violet pigmentary composition prepared according to Example 10, yielding violet fibers which show an attractive strong violet appearance and excellent fastness properties. No pressure build up during the spinning process was observed and no aggregates were noticed in the fibers when viewed under the microscope.

The violet fiber was submitted to an AATC 116-1996 rotary vertical dry crocking test, resulting in an AATCC gray scale note of 5.

Additionally, a chlorinated water test was performed with the violet fiber according to the ISO E03 test procedure. Using the AATCC Gray Scale rating 1 to 5, with 5 showing no color change, a rating note of 3-4 was observed.

### EXAMPLE 23

The procedure of Example 19 is repeated, however, using instead of 2.5 grams of the violet pigmentary composition prepared according to Example 4, the blue pigmentary composition prepared according to Example 11, yielding blue fibers which show an attractive strong blue appearance and excellent fastness properties. No pressure build up during the spinning process was observed and no aggregates were noticed in the fibers when viewed under the microscope.

The blue fiber was submitted to an MTC 116-1996 rotary vertical dry crocking test, resulting in an AATCC gray scale note of 5.

Additionally, a chlorinated water test was performed with the blue fiber according to the ISO E03 test procedure. Using the AATCC Gray Scale rating 1 to 5, with 5 showing no color change, a rating note of 4 was observed.

### EXAMPLE 24

This Example illustrates the incorporation of the inventive pigmentary composition prepared according to Example 13 in mixture with the quinacridone pigment CINQUASIA Red Y RT-759-D, a C.I. Pigment Violet 19 from Ciba Specialty Chemicals Corporation into an automotive paint system.

Millbase Formulation

A pint jar is charged with 48 grams acrylourethane resin from DU PONT, 10.5 grams dispersant resin consisting of 55% of an acrylic resin from DU PONT, and 42.3 grams Solvesso 100 from American Chemical. 15 grams CINQUASIA Red Y RT-759-D, 4.2 grams of the red pigmentary composition obtained according to Example 13 and 240 grams of glass beads are added. The mixture in the jar is shaken on a Skandex shaker for 1 hour. The millbase contains 16.0% pigment with a pigment/binder ratio of 0.5 and a solids content of 48%.

Masstone Color for Spraying a Panel

43.7 grams of the above millbase, 25.4 grams of a clear 47.8% solids unpigmented resin solvent solution, 17.3 grams of a melamine resin from Cyanamid and 14.0 grams of an acrylic urethane polymer solution from DU PONT are mixed and diluted with a solvent mixture comprising 76 parts xylene, 21 parts butanol and 3 parts methanol to a spray viscosity of 20-22 seconds as measured by a #2 Fisher Cup.

The resin/pigment dispersion is sprayed onto a panel twice at 1½ minute intervals as basecoat. After 2 minutes, the clearcoat resin is sprayed twice at 1½ minute intervals onto the basecoat. The sprayed panel is then flashed with air in a flash cabinet for 10 minutes and then “baked” in an oven at 265° F. (129° C.) for 30 minutes, yielding a red colored panel. The coated panel displays an attractive red shade and has excellent fastness to heat, light and migration.

### EXAMPLE 25

The procedure of Example 19 is repeated, however, using instead of 2.5 grams of the violet pigmentary composition prepared according to Example 4, 5.0 grams of the black pigmentary composition prepared according to Example 12, yielding black fibers which show an attractive strong black appearance and excellent fastness properties. No pressure build up during the spinning process was observed and no aggregates were noticed in the fibers when viewed under the microscope. The black fibers show an excellent light stability.

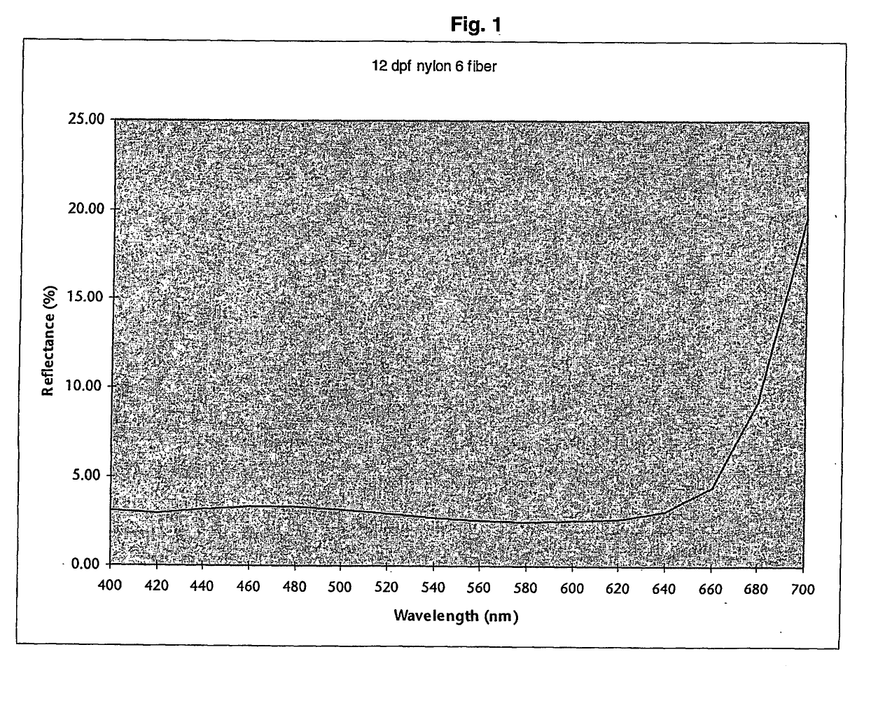

The reflection spectra of the fibers show a strong absorption between 400 and 640 nm and a strong reflection starting in the near infrared region above 640 nm. More particularly, the reflection spectra of the fibers have a reflectance of less than 5% at wavelengths between 400 to 640 nm, and less than 30% at 700 nm, as shown by FIG. 1:

1. A pigmentary composition comprising from 30 to 100 parts by weight of polyamide particles having an average particle size below 50 μm and a coloring agent affixed on or therein, and from 0 to 70 parts by weight of a dye precipitate, wherein the parts by weight of the polyamide particles and precipitate total 100 parts by weight.

2. A pigmentary composition according to claim 1 wherein the average particle size of the polyamide particle is in the range of from 1 to 40 μm.

3. A pigmentary composition according to claim 2 wherein the polyamide particles have a spherical shape.

4. A pigmentary composition according to claim 3 wherein the pores on the polyamide particles at their surface have on average a diameter in the range from 0.05 to 0.6 μM.

5. A pigmentary composition according to any of claims 1 to 4 wherein the coloring agent is an organic dye selected from the group consisting of azo, azomethine, methine, anthraquinone, phthalocyanine, dioxazine, flavanthrone, indanthrone, anthrapyrimidine and metal complex dyes and mixtures thereof.

6. A pigmentary composition according to claim 1 wherein the precipitate consists of a precipitate of formula (I)
[dye]-(Y⁽⁻⁾X⁽⁺⁾ₘ (I)
wherein Y is SO₃, and X⁽⁺⁾ is H⁽⁺⁾ or a group of the formula Mⁿ⁽⁺⁾/n or N⁽⁺⁾(R)(R₁)(R₂)(R₃), M is a monovalent, divalent or trivalent metal cation, n is 1, 2 or 3, each of R, R₁, R₂ and R₃ is independently hydrogen, C₁-C₁₈-alkyl, C₅-C₆-cycloalkyl, phenyl or phenyl which is substituted by C₁-C₁₈-alkyl, or R₂ and R₃, together with the linking nitrogen atom, are a pyrrolidine, imidazoline, piperidine, piperazine, morpholine or abletyl radical, or R₁, R₂ and R₃, together with the linking nitrogen atom, are a pyrrole, pyridine, picoline, pyrazine, quinoline or isoquinoline radical, and m is a value from 1 to 3.

7. A pigmentary composition according to claim 6 wherein X⁽⁺⁾ is H⁽⁺⁾ or Na⁽⁺⁾, K⁽⁺⁾, Mg²⁽⁺⁾, Ca²⁽⁺⁾, Sr²⁽⁺⁾, Ba²⁽⁺⁾, Mn²⁽⁺⁾, Cu²⁽⁺⁾, Ni²⁽⁺⁾, Cd²⁽⁺⁾, Co³⁽⁺⁾, Al³⁽⁺⁾ and Cr³⁽⁺⁾ or N⁽⁺⁾H₄, N⁽⁺⁾H₃CH₃, N⁽⁺⁾H₂ (CH₃)₂, N⁽⁺⁾H₃ C₂H₅, N⁽⁺⁾H₂ (C₂H₅)₂, N⁽⁺⁾H₃ iso-C₃H₇, N⁽⁺⁾H₃ C₆H₁₁)₂, N⁽⁺⁾H₂ (C₆H₁₁)₂, N⁽⁺⁾H₂ (CH₃)C₆H₅), N⁽⁺⁾H₃ C₆ H₅, N⁽⁺⁾H₃ p-n-C₁₈H₃₇—C₆H₅ and N⁽⁺⁾(CH₃)₄.

8. A method for preparing a pigmentary composition according to claim 1 comprising
a. dissolving a coloring agent in an aqueous coloring medium, optionally in the presence of a surface active agent and a buffer,
b. adding polyamide particulates to form a suspension and stirring the suspension at a temperature above room temperature, preferably above 80° C., for 1 to 6 hours to get a high migration,
c. optionally adding an acid and/or a metal salt and/or an organic amine to precipitate the non-migrated dye, and
d. isolating the resulting pigmentary composition by filtration, washing and drying.

9. A method for coloring a solid or liquid substrate comprising incorporating an effective pigmenting amount of a pigmentary composition according to any of claims 1 to 7 into said substrate.

10. A method for coloring a substrate comprising applying a coating composition that contains an effective pigmenting amount of a pigmentary composition according to any of claims 1 to 7.

11. Use of a pigmentary composition according to any of claims 1 to 7 for coloring a substrate.
